(19) United States
(12) Patent Application Publication
(10) Pub. No.: US 2015/0064663 A1
(43) Pub. Date: Mar. 5, 2015

(54) LANGUAGE LEARNING PROGRAM AND COMPUTER READABLE RECORDING MEDIUM HAVING THE SAME

(71) Applicant: Etalk Co., LTD., Seoul (KR)

(72) Inventor: Seung Chul Choi, Seoul (KR)

(21) Appl. No.: 14/474,309

(22) Filed: Sep. 2, 2014

(30) Foreign Application Priority Data
Sep. 2, 2013 (KR) 10-2013-0104969

(51) Int. Cl. G09B 5/06; G09B 19/06

(52) U.S. Cl. CPC G09B 5/065; G09B 19/06
USPC 434/156

(57) ABSTRACT

There are disclosed a computer readable recording media recording a language learning program to execute a method including a first step of receiving input of a first video file selected by a user in a computer, a second step of receiving input of a first text associated with the first video file, and a step of generating an execution file configured to execute the first video file and to stand by in a first state where a voice can be input after executing the first video file.

### TECHNICAL FIELD

Embodiments of the present disclosure relate to a language learning program and a computer readable recording medium for recording the same.

### BACKGROUND

With development of inter-reactive network system (e.g., the internet), on-line learning means instead of off-line learning which requires a preset place and time for a student and a teacher to learn and teach face-to-face is taking long strides.

Diverse usages and systems for learning foreign languages, using such network means, are under development. For instance, with rapid transmission and of a video signal and an audio signal and development of a processing speed, learning means for allowing a local foreigner and a language learner to acquire a foreign language via on-line, viewing a screen.

However, although such diverse means are provided and the much time and efforts taken to earn English are cost, sufficient success cannot be achieved.

### DISCLOSURE

### Technical Problem

To solve the problems, the embodiments of the present disclosure may provide a language learning program and a computer readable recording medium for recording the same.

### Technical Solution

To achieve the object and other advantages and in accordance with the purpose of the embodiments, the embodiments of the present disclosure provide a computer readable recording media recording a language learning program to execute a method including a first step of receiving input of a first video file selected by a user in a computer; a second step of receiving input of a first text associated with the first video file; and a step of generating an execution file configured to execute the first video file and to stand by in a first state where a voice can be input after executing the first video file.

The method may further include a third step of receiving a second video file selected by the user; and a fourth step of receiving input of a second text associated with the second video file, and the execution file may execute the second video file and stand by in a second state where a voice can be re-input from outside, once a voice is input from outside in the first state.

The method may further include a fifth step of receiving input of a third video file selected by the user; and a sixth step of receiving input of a third text associated with the third video file, and the execution file may execute the third video file and stands by in a third state where a voice can be re-input from outside, once a voice can be re-input from outside.

Exemplary embodiments of the present disclosure also provide a computer readable recording media recording a language learning program to execute a method including as a language learning program executed by a user's execution command; a step of executing a first video file when there is the user's execution command; and a step of standing by in a third state where a voice can be input from outside, when the execution of the first video file is complete.

The method may further include a step of receiving input of a voice in the first state; a step of executing a second video file once the step of receiving the input of the voice is complete; and a step of standing by in a second state where a voice can be input from outside, when the execution of the second video file is complete.

The method may further include a step of receiving input of a voice from outside in the second state; a step of executing a third video file when the step of receiving the input of the voice in the second state is complete; and a step of standing by in a third state where a voice can be input from outside, when the execution of the third video file is complete.

The method may further include a step of comparing the voice input from the outside in the first state with a text pre-stored in association with the first video file.

The method may further include a step of displaying the pre-stored text associated with the first video file.

Exemplary embodiments of the present disclosure may also provide a terminal including a computer processor; a memory; and a language learning program loaded in the memory under control of the computer processor to be executed, wherein the terminal is configured to execute a method including a step of executing a first video file when there is an execution command input by a user; and a step of standing by in a first state where a voice can be input from outside, when the execution of the first video file is complete.

The method may further include a step of receiving input of a voice from outside in the first state; a step of executing a second video file when the step of receiving the voice is complete.

The method may further include a step of receiving input of a voice from outside in the second state; a step of executing a third video file when the step of receiving the voice in the second state is complete; and a step of standing by in a third state where a voice can be input from outside, when the execution of the third video file is complete.

The terminal may further include a camera for capturing a user's image, wherein the method may further include a step of determining whether the user's mouth moves, using the user's image captured by the camera, and the terminal may stand by in the second state, only when the user's mouth moves based on the result of the determination even after the execution of the second video file is complete.

The terminal may further include a camera for capturing the user's image, wherein the method may further include a step of determining a direction of the user' face, using the user's image captured by the camera, and the terminal may stand by in the second state, only when the direction of the user's face is toward a direction in which the second video file is executed even after the execution of the second video file is complete.

### Advantageous Effects

According to the embodiments mentioned above may have following advantageous effects, the language learning can be performed in the conversation type and languages such as English, Chinese, and Japanese and so on can be learned interestingly.

Furthermore, languages such as English, Chinese and Japanese can be learned in a conversation type, using the video files a language learner prefers. Accordingly, the language learner can be motivated to study more.

### BRIEF DESCRIPTION OF THE DRAWINGS

FIG. 1 is a diagram illustrating that a conversation-based language learning application according to one embodiment of the present disclosure is provided in a terminal;

FIG. 2 is a flow chart illustrating an operation performed by the conversation-based language learning application according to the embodiment of the disclosure to generate an implementing file for learning;

FIG. 3 is a flow chart illustrating an operation of the implementing file for learning generated by the conversation-based language learning application according to the embodiment of the disclosure; and

FIG. 4 is a flow chart illustrating an operation of a language learning application according to the embodiment of the present disclosure.

### BEST MODE

Exemplary embodiments of the disclosed subject matter are described more fully hereinafter with reference to the accompanying drawings. The disclosed subject matter may, however, be embodied in many different forms and should not be construed as limited to the exemplary embodiments set forth herein. Rather, the exemplary embodiments are provided so that this disclosure is thorough and complete, and will convey the scope of the disclosed subject matter to those skilled in the art. In the drawings, the size and relative sizes of layers and regions may be exaggerated for clarity. Like reference numerals in the drawings denote like elements.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, or section from another region, layer or section. Thus, a first element, component, region, layer, or section discussed below could be termed a second element, component, region, layer, or section without departing from the teachings of the present disclosure.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, or section from another region, layer or section. Thus, a first element, component, region, layer, or section discussed below could be termed a second element, component, region, layer, or section without departing from the teachings of the present disclosure.

The terminology used herein is for the purpose of describing exemplary embodiments only and is not intended to be limiting of the disclosed subject matter. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

When a first element (or component) is operated or implemented on a second element (or component), it will be understood that the first element is operated or implemented in an environment where the second element is operated or implemented or the first element is operated or implemented after direct or indirect mutual activation with the second element.

When an element, component, device or system comprises a program or software, it will be understood that the element, component, device or system should comprise a hardware (e.g., a memory, CPU and so on) required to implement the program or software, or another program or a software (e.g., a driver required to drive a operation system or a hardware, even without clear specification.

It will be further understood that an element (or a component) can be realized into software, hardware or any types of soft and hardware, unless the context clearly indicates otherwise.

Exemplary embodiments of the disclosed subject matter are described herein with reference to cross-section illustrations that are schematic illustrations of idealized embodiments (and intermediate structures) of the disclosed subject matter. As such, variations from the shapes of the illustrations as a result, for example, of manufacturing techniques and/or tolerances, are to be expected. Thus, exemplary embodiments of the disclosed subject matter should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this disclosed subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

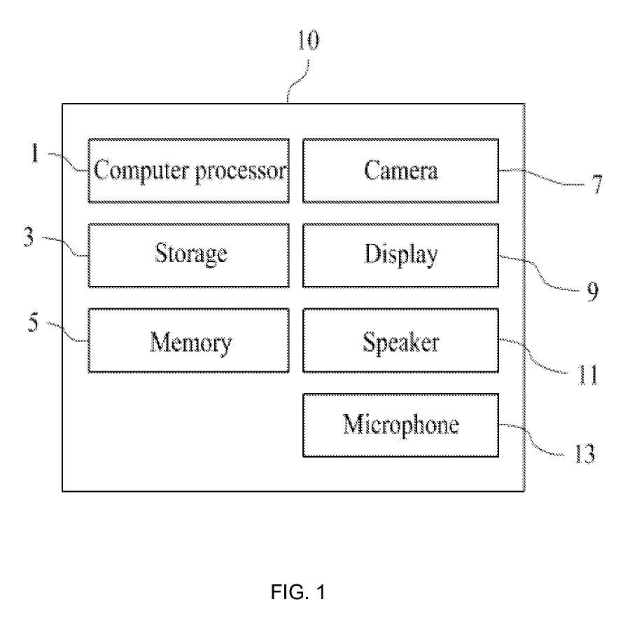

FIG. 1 is a diagram illustrating that a conversation-based language learning application according to one embodiment of the present disclosure is provided in a terminal 10.

Referring to FIG. 1, the terminal 10 according to one embodiment of the present disclosure may include a computer processor 1, a storage 3, a memory 5, a camera 7, a display 9, a speaker 11 and a microphone 13.

The conversation-based language learning application (hereinafter, a language learning application) according to the embodiment of the present disclosure is stored in the storage 3 and loaded in the memory 5 to be implemented (or ‘operated’).

The computer processor 1 may control overall operation of the storage 3, the memory 5, the camera 7, the display 9 and the speaker 11.

The storage 3 stores programs and data required for the operation of the terminal therein.

The camera 7 may capture an external image and the speaker 11 may output a voice outside. The microphone 13 may receive a voice from a user.

The camera 7 according to the embodiment of the present disclosure may capture the user's image. The language learning application and/or wish pack execution file may be activated to operate the camera 7 and the microphone 13. Also, it may activate the camera 7 to capture an image, in case of gaining the image from the user. In case of needing to receive input of the user's voice, the language learning application and/or wish pack execution file may activate the microphone 13 to receive the voice.

Although not shown in the drawings, the terminal may include a program for display a keyboard used in inputting a command or data via the display 9 by the user. Such a program may be loaded in the memory 5 under the control of the computer processor 11 to operate.

Hereinafter, a schematic principle of the present disclosure will be described.

It is assumed that the wish pack execution file generated according to the embodiment of the present disclosure is implemented in the terminal (it is assumed that a video file A1, a text file B1, a video file A2, a text file B2, a video file A3 and a text file B3 are associated).

In this instance, the wish pack execution file plays the video file A1 first and stands by in a state where a text (via a voice or a keyboard) can be input by the user (hereinafter, a first state), after the playing.

In the first state, the text (via the voice or keyboard) is input to the wish pack execution file from the user via the voice and the wish pack execution file plays the video file A2 after the completion of the input. Once playing the video file A2, the wish pack execution file stands by in a state where a text (via the voice or keyboard) can be input by the user (in a second state).

The text is input to the wish pack execution file from the user via the voice and the wish pack execution file plays the video file A3 after the input. Once playing the video file A3, the wish pack execution file stands by in a state where a text (via the voice or keyboard) can be input by the user (in a third state). Once inputting the user's input of the text in the third state (via the voice or keyboard), the operation of the wish pack execution file is complete.

In the first, second and third states, the microphone 13 may be activated by the wish pack execution file or the language learning program.

For easy understanding, examples of conversations made in the video file A1, the video file B1, the video file A2, the text file B2, the video file A3 and the text file B3 will be described hereinafter.

A1: (video file) why didn't you show up in the place?

B1: I had another appointment.

A2: (video file) you could have told me that. I was waiting for you so long.

B2: So sorry and I'm deeply ashamed of myself.

A3: (video file) get out of my life.

B3: please, forgive me.

In this instance, the video file may be the excerpt from what a famous actress is said in a foreign movie or what is written by the user directly. When an object of the learning is a child, the video file may be the excerpt from English version of “Pororo”. The video files provided in the wish pack may be the video files created by the user directly, considering the language learning application user's age or job or the excerpts from other video files.

Meanwhile, the language learning application according to the embodiment of the may perform at least one of following operations:

1) generating a file called “Wish pack execution file” mentioned above; and

2) a function of a “Wish pack execution file” player.

In other words, the language learning application according to the embodiment of the present disclosure may perform one of the two operations mentioned above or both of the operations.

1. The Generation of the Wish Pack Execution File:

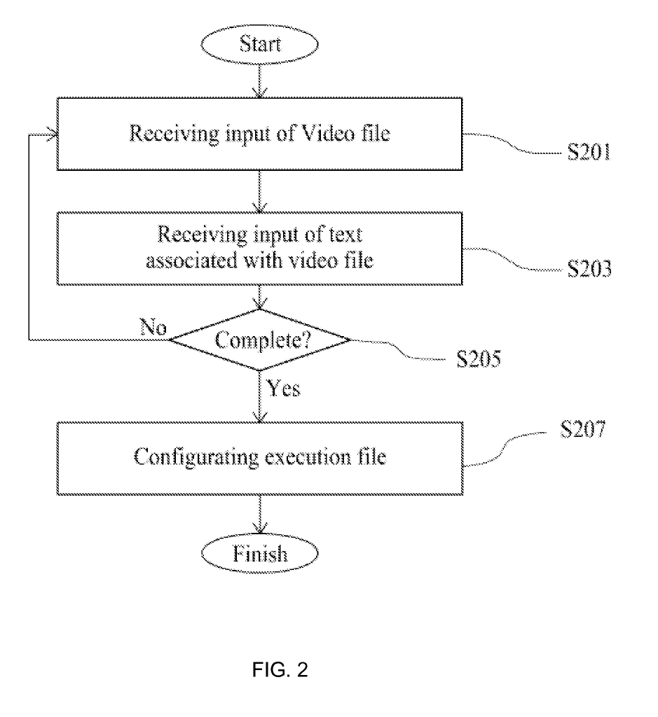

The language learning application according to the embodiment of the disclosure may generate the wish pack execution file. For instance, the language learning application may generate the wish pack execution file based on a flow chart shown in FIG. 2.

Referring to FIG. 2, the language learning application according to the embodiment of the disclosure may perform a step of receiving input of a video file (S203), a step of determining whether S203 is complete (S205) and a step of configurating an execution file (S207).

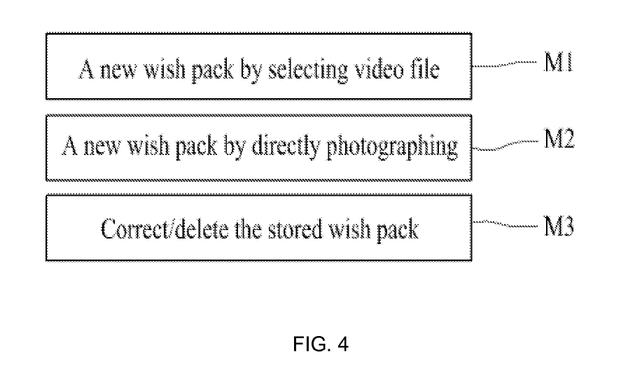

The language learning application according to the embodiment of the present disclosure may display menus (M1, M2 and M3) shown in FIG. 4 on the display 9, for instance.

For instance, when the user selects a new wish pack menu (M1) by selecting a video file, video files are displayed on the display 9 as selection candidates. In this instance, it will be understood that the terminology of “display” means displaying on the display 9, unless specifying it with special mention.

The user may select one of the displayed video files (or a video file A1) (S201).

Once S210 is complete, the language learning application may display a screen having a menu (a text input menu) to input a text associated with the video file selected in S201.

The user may input a text input via the keyboard or voice to the text input menu (“text file B1”). Unless the user inputs more video files after the user completes the input of the text (S205: yes), the language learning application may generate “Wish pack execution file”, using the video file A1 and the text file B1. The generated wish pack execution file play the video file A1 and stands by in the state where a text file can be input. Once the user inputs the text (via the voice or keyboard), the language learning application may finish.

Meanwhile, when there is more video files selected to be input by the user (S205: No), the language learning application re-perform the steps of S201 through S203. In other words, the language learning application receive the user's input of a video file (“video file A2) in S201 and then receive input of a text associated with the video file A2 (“text file B2”) in S203.

Once the user's input of the text is complete, with no more video files input by the user (S205: Yes), the language learning application may generate “Wish pack execution file”, using the video file A1, the text file B1, the video file A2 and the text file B2. The generated wish pack execution file play the video file A1 and then stands by in a state where a text can be input. When there is the user's input of text (via the voice or keyboard), the language learning application plays the video file A2. When there is the user's input of a text (via the voice or keyboard), the language learning application finishes.

Meanwhile, when there is more image file selected to be input by the user (S205: No), the language learning application re-perform the steps of S201 through S203. In other words, a video file (“video file A3”) is input by the user in S201 again and texts associated with the video file A2 (“text file B3) is input in S203.

Once the user's input of the text is complete, with no more video files input by the user (S205: Yes), the language learning application may generate “Wish pack execution file”, using the video file A1, the text file B1, the video file A2, the text file B2, the text file A3 and the text file B3. The generated wish pack execution file play the video file A1 and then stands by in a state where a text can be input. When there is the user's input of text (via the voice or keyboard), the language learning application plays the video file A3. When there is the user's input of a text (via the voice or keyboard), the language learning application finishes.

As mentioned above, referring to FIG. 2, the language learning application according to the embodiment of the disclosure may generate the wish pack execution file generated in relation with the video file and the text file in a conversation type and provide the user with a screen for generating the wish pack execution file.

2. Execution of Wish Pack Execution File:

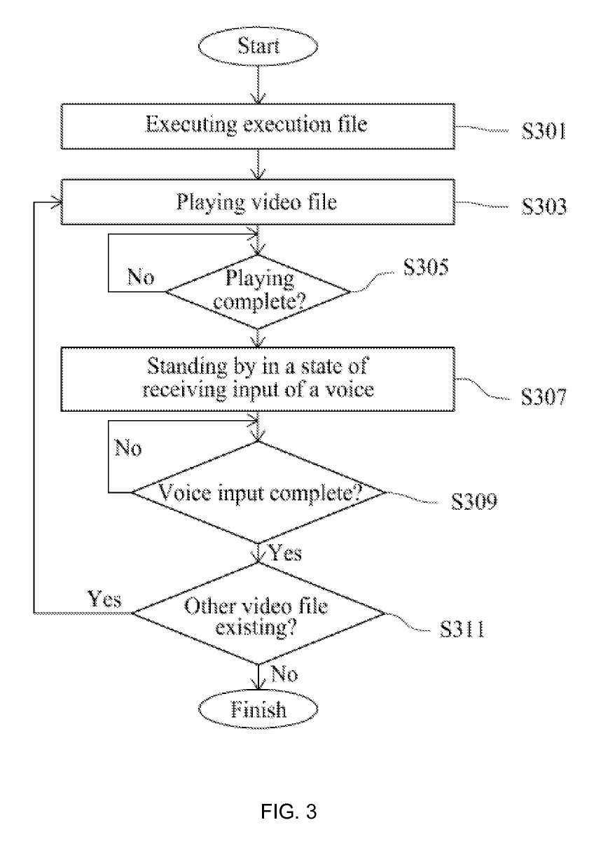

FIG. 3 is a flow chart illustrating an operation of the implementing file for learning generated by the conversation-based language learning application according to the embodiment of the disclosure.

Referring to FIG. 3, the operation of the wish pack execution file generated as shown in FIG. 2 will be described hereinafter. The embodiment shown in FIG. 3 will be described, assuming that “Wish pack execution file” associated with the video file A1, the text file B1, the video file A2, the text file B2, the video file A3 and the text file B3 is generated.

Once the wish pack execution file is implemented (S301), the wish pack execution file plays the video file A1 (S303). After the video file A1 is played completely (S305), the wish pack execution file stands by in a state where the voice can be input (e.g., a screen displaying a text of “input Voice” is provided) (S307). Once the user's input of the voice is complete (S309), it is determined whether there are other video files to be input (S311). In this embodiment, the wish pack execution file includes three video files and steps are re-performed from S303. In other words, the video file A2 is played in S303. After that, the steps to S309 are re-performed repeatedly until the video file A3 is played.

In the embodiment shown in FIG. 3, video files provided in the wish pack execution file are played sequentially. The operation of standing by in the state where the voice can be input whenever the playing of each video file is complete may be repeated. The embodiment shown in FIG. 3 may be performed by the terminal shown in FIG. 1.

Meanwhile, the embodiment shown in FIG. 3 may be diversely modified as follows.

As one example of the modifications, the embodiment shown in FIG. 3 may further include a step of determining whether the user's mouth moves, using the user's image captured by the camera 7. Only when it is determined that the user's mouth moves even after the playing is complete in S305, S307 may be performed.

As another example, the embodiment shown in FIG. 3 may further include a step of determining a direction of the user's face, using the user's image which is performed between S305 and S307. In this instance, it is determined whether the user's face is toward the display 9 of the terminal, using the user's image captured by the camera 7. Only when the user's face is toward the display 9 based on the result of the determination even after the playing is complete in S305, S307 may be performed.

As a third example, the wish pack execution file may further include a step of comparing the voice input by the user with a preset text file. For instance, the step of comparing may be provided between S309 and S311 and the step of comparing may show the user the result of the comparison.

As a fourth example, the wish pack execution file may further include a step of displaying a screen of a text file associated with the video file played currently. For instance, the step of displaying the text file may be provided between S309 and S311.

One or more of the examples may be combinedly realized. This embodiment may be realized to be applied to language learning and it may be applied to other fields.

Although embodiments have been described with reference to a number of illustrative embodiments thereof, it should be understood that numerous other modifications and embodiments can be devised by those skilled in the art that will fall within the spirit and scope of the principles of this disclosure.

1. A computer readable recording media recording language learning program to execute a method comprising:
a first step of receiving input of a first video file selected by a user in a computer;
a second step of receiving input of a first text associated with the first video file; and
a step of generating an execution file configured to execute the first video file and to stand by in a first state where a voice can be input after executing the first video file.

2. The computer readable recording media recording the language learning program of claim 1, wherein the method further comprises,
a third step of receiving a second video file selected by the user; and
a fourth step of receiving input of a second text associated with the second video file, and
the execution file executes the second video file and stands by in a second state where a voice can be re-input from outside, once a voice is input from outside in the first state.

3. The computer readable recording media recording the language learning program of claim 2, wherein the method further comprises,
a fifth step of receiving input of a third video file selected by the user; and
a sixth step of receiving input of a third text associated with the third video file, and
the execution file executes the third video file and stands by in a third state where a voice can be re-input from outside, once a voice can be re-input from outside.

4. A computer readable recording media recording a language learning program to execute a method comprising: as a language learning program executed by a user's execution command
a step of executing a first video file when there is the user's execution command; and
a step of standing by in a third state where a voice can be input from outside, when the execution of the first video file is complete.

5. The computer readable recording media recording the language learning program of claim 4, wherein the method further comprises,
a step of receiving input of a voice in the first state;
a step of executing a second video file once the step of receiving the input of the voice is complete; and
a step of standing by in a second state where a voice can be input from outside, when the execution of the second video file is complete.

6. The computer readable recording media recording the language learning program of claim 5, wherein the method further comprises,
a step of receiving input of a voice from outside in the second state;
a step of executing a third video file when the step of receiving the input of the voice in the second state is complete; and
a step of standing by in a third state where a voice can be input from outside, when the execution of the third video file is complete.

7. The computer readable recording media recording the language learning program of claim 5, wherein the method further comprises,
a step of comparing the voice input from the outside in the first state with a text pre-stored in association with the first video file.

8. The computer readable recording media recording the language learning program of claim 2, wherein the method further comprises,
a step of displaying the pre-stored text associated with the first video file.

9. A terminal comprising:
a computer processor;
a memory; and
a language learning program loaded in the memory under control of the computer processor to be executed,
wherein the terminal is configured to execute a method comprising:
a step of executing a first video file when there is an execution command input by a user; and
a step of standing by in a first state where a voice can be input from outside, when the execution of the first video file is complete.

10. The terminal of claim 9, wherein the method further comprises,
a step of receiving input of a voice from outside in the first state;
a step of executing a second video file when the step of receiving the voice is complete.

11. The terminal of claim 10, wherein the method further comprises,
a step of receiving input of a voice from outside in the second state;
a step of executing a third video file when the step of receiving the voice in the second state is complete; and
a step of standing by in a third state where a voice can be input from outside, when the execution of the third video file is complete.

12. The terminal of claim 10, further comprising:
a camera for capturing a user's image,
wherein the method further comprises,
a step of determining whether the user's mouth moves, using the user's image captured by the camera, and
the terminal stands by in the second state, only when the user's mouth moves based on the result of the determination even after the execution of the second video file is complete.

13. The terminal of claim 10, further comprising a camera for capturing the user's image,
wherein the method further comprises,
a step of determining a direction of the user' face, using the user's image captured by the camera, and
the terminal stands by in the second state, only when the direction of the user's face is toward a direction in which the second video file is executed even after the execution of the second video file is complete.
